(19) United States
(12) Patent Application Publication
(10) Pub. No.: US 2002/0052147 A1
(43) Pub. Date: May 2, 2002

(54) Card connector

(76) Inventor: Shigeru Sato, Chiba-shi (JP)

Correspondence Address: Finnegan, Henderson, Farabow,, Garrett & Dunner, L.L.P., 1300 I Street, N.W., Washington, DC, 20005-3315, US

(21) Appl. No.: 09/978,664

(22) Filed: Oct. 18, 2001

(30) Foreign Application Priority Data
Oct. 19, 2000 (JP) 2000-319892

(51) Int. Cl. H01R 24/00

(52) U.S. Cl. 439/630

(57) ABSTRACT

The present invention is intended to achieve a reduction in the thickness of the connector housing. To this end, the connector housing is constructed in such a way that the first card accommodating portion for accommodating the first card and the second card accommodating portion for accommodating the second card are arranged one upon the other and that the arrangement direction of the contact terminals for the first card and the arrangement direction of the contact terminals for the second card are set almost perpendicular to each other.

### BACKGROUND OF THE INVENTION

1. Field of the Invention

The present invention relates to a card connector mounted on electronic devices, such as cellular phones, telephones, PDAs (personal digital assistants), portable audio devices and cameras, and more specifically to a card connector capable of simultaneously accommodating at least two different cards with different external shapes and different contact pad positions.

2. Description of the Related Art

In electronic devices such as cellular phones, telephones, PDAs and cameras, a variety of functions are added by inserting an IC card with a built-in memory IC, such as a SIM (subscriber identity module) card, an MMC (multimedia card), a Smart Media (tradename), an SD (super density; or secure digital) card and a Memory Stick (tradename).

The connector structure for removably accommodating such an IC card has a plurality of contact terminals in a connector housing that are connected to a variety of signal processing circuits and a power supply circuit of the electronic device on which the connector is mounted. These contact terminals are brought into contact with a plurality of contact pads formed on a front or back surface of the inserted IC card to electrically connect the IC card to the electronic device on which the connector is mounted.

There are various kinds of such cards with different external shapes and different contact pad positions. For an electronic device to be able to accept a plurality of kinds of cards, a card connector is being called for which allows simultaneous insertion of different kinds of cards.

In an example card connector that allows simultaneous insertion of two kinds of cards, card slots may be arranged laterally horizontally for receiving two different types of cards.

When the cards are horizontally arranged side by side, an area that the connector occupies on a circuit board becomes large, which is detrimental to reducing the size of the electronic device.

In another example of the connector capable of receiving two kinds of cards, an arrangement may be made to allow two cards to be inserted in a vertically stacked relationship.

A housing of the card connector of this construction has formed therein an accommodating portion for receiving a card inserted from an upper slot and an accommodating portion for receiving a card inserted from a lower slot. A plate member that separates the upper and lower accommodating portions has secured to its upper and lower surf aces contact terminals that are brought into electric contact with the cards inserted from the respective slots. A commonly used manufacturing process fits the contact terminals under pressure into press-fit grooves formed in the plate member of the housing. In the conventional card connector, because the contact terminals for two kinds of cards are arranged in the same direction with respect to the card housing, the press-fit grooves in which to install the contact terminals for the two different types of cards may vertically overlap. In that case, in order to form the press-fit grooves in both the upper and lower surfaces of the plate member, the thickness of the plate member needs to be set larger than the sum of a depth of the upper press-fit grooves and a depth of the lower press-fit grooves. This increases the overall thickness of the connector, giving rise to a problem that the reduction in the size of an electronic device may be hindered. Another problem is that the soldered portions of the contact terminals concentrate on localized portions of the card housing and thus interfere with one another, making the layout of contact terminals very difficult.

### SUMMARY OF THE INVENTION

The present invention has been accomplished to overcome the above-described problems. It is therefore lo an object of this invention to provide a card connector which can accommodate two or more kinds of cards, reduce a connector-occupied area on a printed circuit board and a thickness of the connector and facilitate the layout of contact terminals.

According to one aspect, the present invention provides a card connector for holding in a connector housing at least two kinds of cards, a first card and a second card, in such a manner that contact pads of these cards engage contact terminals installed in the connector housing, the connector housing comprising: a first card accommodating portion having contact terminals installed therein for electric contact with the first card and designed to accommodate the first card; and a second card accommodating portion having contact terminals installed therein for electric contact with the second card and designed to accommodate the second card; wherein the first and second card accommodating portions are arranged one upon the other; wherein a direction of arrangement of the contact terminals for the first card and a direction of arrangement of the contact terminals for the second card are set almost perpendicular to each other.

In this invention because the first card accommodating portion for accommodating the first card and the second card accommodating portion for accommodating the second card are arranged one upon the other in such a way that the arrangement direction of the contact terminals to be connected with the first card and the arrangement direction of the contact terminals to be connected with the second card are almost perpendicular to each other, the press-fit portions for the first card contact terminals and the press-fit portions for the second card contact terminals do not overlap, allowing the connector to be reduced in thickness. This arrangement also prevents interference between the soldered portions of the contact terminals for the first card and the soldered portions of the contact terminals for the second card even when the slots for two kinds of card are arranged one upon the other.

According to another aspect, the present invention provides a card connector in which the first card is larger in size than the second card and in which the first card accommodating portion is arranged in a lower part of the connector housing and the second card accommodating portion is arranged in an upper part of the connector housing. A single door type open/close cover is provided at a top opening of the second card accommodating portion arranged in the upper part of the connector housing. The open/close cover is opened and closed about a rotating shaft extending in the same direction as the direction of arrangement of the contact terminals for the second card (i.e., extending along a longer side of the loaded second card). Then, a locking means for locking the open/close cover in a closed position is arranged on that side of the second card accommodating portion which is opposite the rotating shaft.

In this invention, because the open/close cover for the second card accommodating portion, which is arranged in the upper part of the housing, is opened and closed about the rotating shaft extending along the longer side of the second card, not the shorter side, it is possible to arrange the locking mechanism for the open/close cover at an upper surface portion of the first card accommodating portion on that side of the second card accommodating portion which is opposite the rotating shaft extending along the longer side of the second card. When the arrangement direction of the contact terminals to be electrically connected with the first card and the arrangement direction of the contact terminals to be electrically connected with the second card are set almost perpendicular to each other, because the second card is smaller than the first card, the portion on the side opposite the rotating shaft is an unoccupied area where no other parts need to be located. Thus, the locking mechanism can be arranged in this unused area, thus preventing an increase in the connector installation area.

The above and other objects, effects, features and advantages of the present invention will become more apparent from the following description of embodiments thereof taken in conjunction with the accompanying drawings.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view showing an embodiment of a card connector according to the present invention, with an open/close cover open;

FIG. 2 is a perspective view showing the embodiment of the card connector according to the present invention, with an open/close cover closed;

FIG. 3 is a plan view showing the embodiment of the card connector according to the present invention, with an open/close cover closed;

FIG. 4 is a plan view showing an upper card accommodating portion, with the open/close cover omitted, in the embodiment of the card connector according to this invention;

FIG. 5 is a plan view showing a lower card accommodating portion, with the upper card accommodating portion omitted, in the embodiment of the card connector according to this invention; and

FIG. 6 is an enlarged perspective view showing an area A of FIG. 2 in the embodiment of the card connector according to this invention.

### DETAILED DESCRIPTION OF PREFERRED EMBODIMENTS

An embodiment of the present invention will be described in detail with reference to the accompanying drawings.

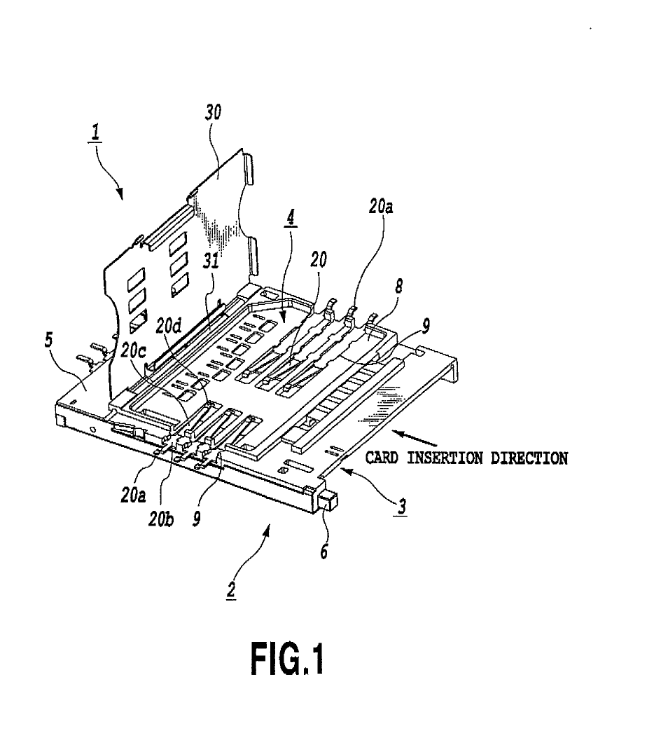

FIGS. 1 to 6 show an embodiment of the card connector according to this invention. FIG. 1 is a perspective view showing the open/close cover open;

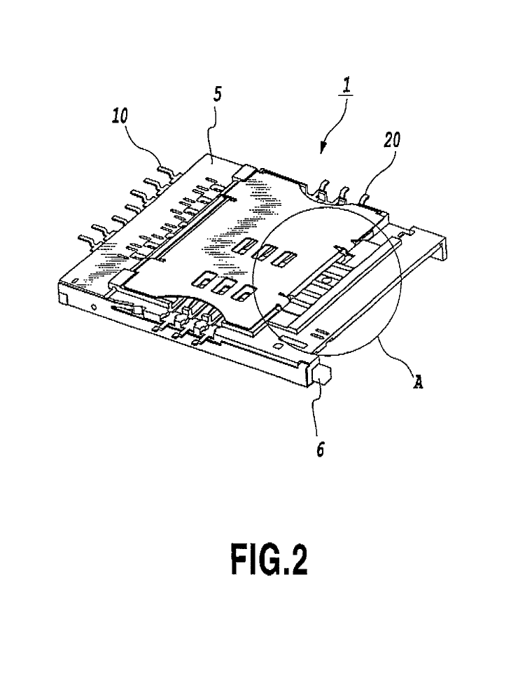

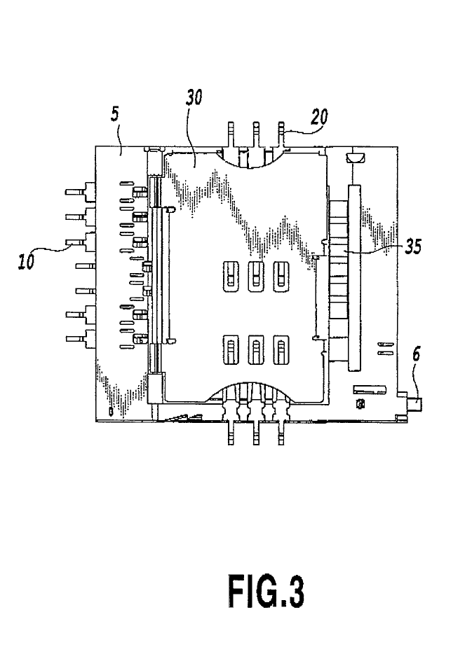

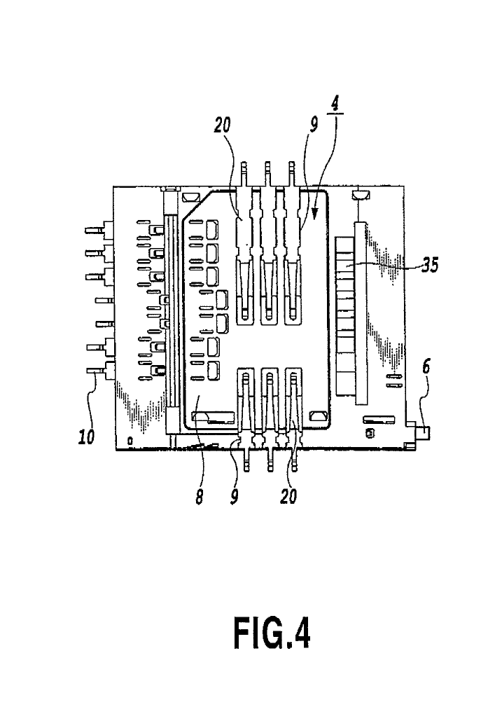

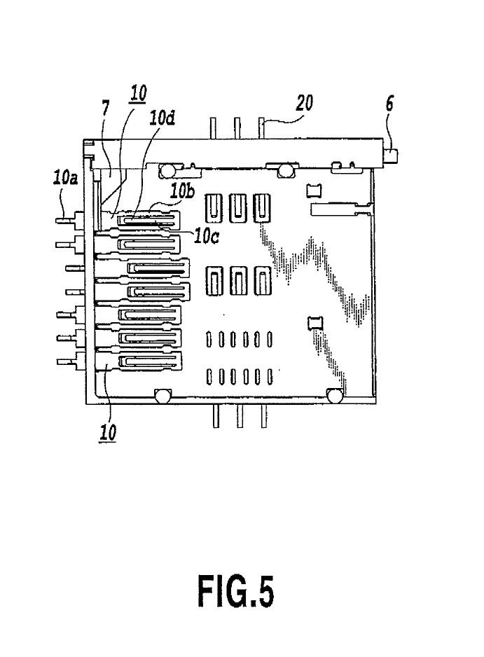

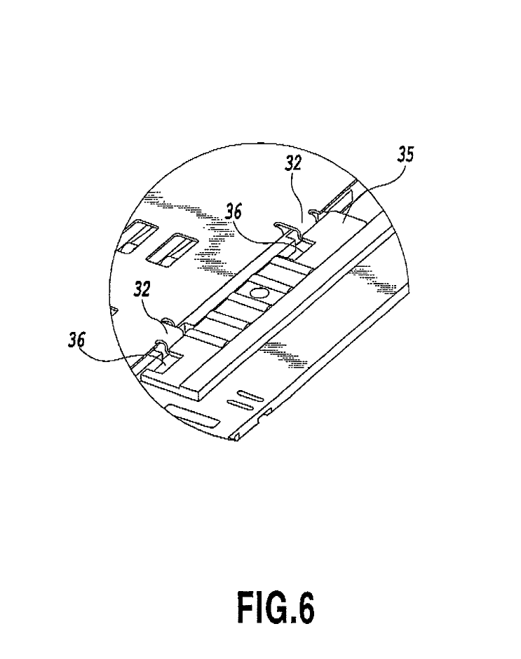

FIG. 2 is a perspective view showing the open/close cover closed; FIG. 3 is a plan view showing the open/close cover closed; FIG. 4 is a plan view showing an upper card accommodating portion, with the open/close cover omitted; FIG. 5 is a plan view showing a lower card accommodating portion, with the upper card accommodating portion omitted; and FIG. 6 is an enlarged perspective view of an area A of FIG. 2.

The card connector shown in these figures can receive two kinds of cards with different sizes (a large card and a small card) at the same time, with the large card slid into the lower slot from the side (side loading) and with the small card inserted into the upper slot from the top (top loading).

The card connector of this embodiment is assumed to be mounted in a cell phone.

In the card connector of this embodiment a SIM card (Subscriber Identity Module Card) is inserted as a small card. The SIM card is a kind of an IC card which normally contains a variety of information including a subscriber ID of the cell phone. This small card has a plurality (normally six) of contact pads formed at its bottom.

As a large card an MMC card is used. The MMC card may contain a variety of content such as music and games. This large card also has a plurality (in this case seven) of contact pads formed at its bottom.

Comparison between the large card and the small card shows that the longitudinal length of the small card is almost equal to the length of a shorter side of the large card.

The card connector 1 shown in FIGS. 1 to 6 has a connector housing 2 molded from an insulating material such as resin.

The connector housing 2 has a lower card accommodating portion 3 for accommodating a large card and a upper card accommodating portion 4 for accommodating a small card.

On both sides of the lower card accommodating portion 3 are formed guide grooves (not shown) that guide a large card as it is inserted or retracted. The large card is inserted or withdrawn along the guide grooves with its contact pad surface facing up,

A top plate portion 5 that defines the lower card accommodating portion 3 is formed on its inner side with a plurality of press-fit grooves (press-fit portions), not shown, in which to position and install under pressure a plurality (in this case seven) of large card contact terminals 10

Each of the contact terminals 10 is made from a cantilevered contact leaf spring and, as shown in FIG. 5, comprises a soldered portion 10a soldered to the corresponding contact pad of the printed circuit board of the electronic device, a fixed portion 10b constituting an outer frame of the contact terminal and secured in the press-fit groove, an elastically displaceable contact spring portion 10c extending from the fixed portion lob toward the soldered portion 10a, and a contact portion 10d protruding downward to engage the contact pad of the large card.

When a large card is inserted into the lower card accommodating portion 3 with its contact pad surface facing up, the contact pads of the large card engage the contact portions 10d of the contact terminals 10 installed in the lower card accommodating portion 3.

At one side of the lower card accommodating portion 3 there is arranged an eject mechanism (not shown) linked to an eject button 6 and an eject member 7. The eject member 7 is moved toward the rear end of the housing as the large card is inserted into the lower card accommodating portion 3, and is locked at a predetermined position in the rear part of the housing by the action of the eject mechanism. When the eject button 6 is pressed, the eject mechanism unlocks the eject member 7 which then moves toward the front of the housing ejecting the large card

The upper card accommodating portion 4 is open upward and receives a small card from above in a “stop loading” manner.

A bottom plate portion 8 of the upper card accommodating portion 4 is formed with a plurality of press-fit grooves 9 in which to position and install a plurality (in this case six) of small card contact terminals 20.

There are two kinds of contact terminals 20 for a small card, One kind is made from a long cantilevered contact leaf spring and the other from a short cantilevered contact leaf spring. Each of the small card contact terminals 20 comprises a soldered portion 20a soldered to the corresponding contact pad of the printed circuit board of the electronic device, a fixed portion 20b to be securely installed in the press-fit groove 9, an elastically displaceable contact spring portion 20c, and a contact portion 20d protruding upward to engage the corresponding small card contact pad.

The direction of arrangement of the small card contact terminals 20 is almost perpendicular to that of the large card contact terminals 10.

When a small card is loaded into the upper card accommodating portion 4 with its contact pad surface facing down, the contact pads of the small card engage the contact portions 20d of the contact terminals 20.

An open/close cover 30 is provided for closing a top opening of the upper card accommodating portion 4. The open/close cover 30 is rotated open, like a single door, about a rotating shaft 31 provided at one side of the top opening. The rotating shaft 31 extends in the same direction as the arrangement direction of the small card contact terminals 20, i.e., in the direction of a longer side of the loaded small card.

A slide lock member 35 as a means for locking the open/close cover 30 in the closed position is provided on a side of the upper card accommodating portion 4 opposite the rotating shaft 31. As shown in FIG. 6, the slide lock member 35 can be slid relative to the connector housing between two positions. When the slide lock member 35 is set to a position where a notch 36 of the slide lock member 35 opposes a locking piece 32 of the open/close cover 30, the open/close cover 30 can be opened.

In this embodiment, the lower card accommodating portion 3 for receiving a large card and the upper card accommodating portion 4 for receiving a small card are arranged one upon the other in such a manner that the direction of arrangement of the large card contact terminals 10 is almost perpendicular to that of the small card contact terminals 20. In this arrangement, the press-fit grooves (press-fit portions) for the large card contact terminals 10 and the press-fit grooves (press-fit portions) 9 for the small card contact terminals 20 do not overlap vertically, making it possible to reduce the thickness of the connector housing and at the same time prevent the interference between the soldered portions 10a of the large card contact terminals 10 and the soldered portions 20a of the small card contact terminals 20. This in turn facilitates the assembly work of fitting the contact terminals and the image inspection of soldered portions and solder during an. on-board mounting process. A repair work using an electric soldering iron can also be facilitated.

Further, in this embodiment the open/close cover 30 for the upper card accommodating portion 4 is opened and closed about the rotating shaft 31 extending in the direction of a longer side of the card, not in the shorter-side direction. This arrangement allows the locking mechanism (slide lock member) 35 of the open/close cover 30 to be located in a spacious unoccupied area on the upper side of the lower card accommodating portion 3, thus preventing an increase in the area occupied by the connector. If the open/close cover 30 is opened and closed about a rotating shaft extending along a shorter side of the small card, for example, the looking mechanism of the open/close cover 30 must be arranged in a very narrow area on the side opposite the rotating shaft, making it necessary to secure an additional space for the locking mechanism. This in turn increases the connector-occupied area on the printed circuit hoard, preventing a size reduction of the electronic device.

While in the embodiment above two kinds of cards different in size, large and small, are loaded into the card connector, the cards to be loaded in a tiered relation may be of the same size. In essence, the card connector of this invention can accommodate two or more kinds of cards of different shapes.

Although in the embodiment above a SIM card is used as a small card and an MMC card as a large card, the card to be loaded may be arbitrary including Smart Media (tradename), SD card and Memory Stick (tradename).

The application of the card connector of this invention is not limited to cellular phones but may include other electronic devices such as PDAs, portable audio devices and cameras.

With this invention, because the upper and lower card accommodating portions for two kinds of cards are arranged one on the other so that the contact terminal arrangement directions for the two cards are almost perpendicular to each other, as described above, the contact terminals for these cards do not overlap each other. This allows the thickness of the connector housing to be reduced and prevents the soldered portions of the contact terminals for one card from interfering with those for the other card.

In this invention because the single door type open/close cover that closes the upper card accommodating portion opens and closes about a rotating shaft extending along a longer side of the small card, the locking mechanism for the cover can be installed in a spacious unused area, thus preventing an increase in an area occupied by the connector.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A card connector for holding in a connector housing at least two kinds of cards, a first card and a second card, in such a manner that contact pads of these cards engage contact terminals installed in the connector housing, the connector housing comprising:
a first card accommodating portion having contact terminals installed therein for electric contact with the first card and designed to accommodate the first card, and
a second card accommodating portion having contact terminals installed therein for electric contact with the second card and designed to accommodate the second card;
wherein the first and second card accommodating portions are arranged one upon the other;
wherein a direction of arrangement of the contact terminals to be electrically connected with the first card and a direction of arrangement of the contact terminals to be electrically connected with the second card are set almost perpendicular to each other.

2. A card connector according to claim 1, wherein the first card is larger in size than the second card, the first card accommodating portion is arranged in a lower part of the connector housing, and the second card accommodating portion is arranged in an upper part of the connector housing.

3. A card connector according to claim 1, wherein the connector housing has formed in one surface thereof groove-shaped press-fit portions in which to press-fit first contact terminals and in the other surface thereof groove-shaped press-fit portions in which to press-fit second contact terminals.

4. A card connector according to claim 2, wherein the first card is slid into the first card accommodating portion from a side opening formed in one side of the connector housing, and the second card is loaded into the second card accommodating portion in a top loading manner from a top opening formed in a top surface of the connector housing.

5. A card connector according to claim 3, wherein at the top opening of the second card accommodating portion is provided a single door type open/close cover which has a rotating shaft extending in the same direction as the direction of arrangement of the contact terminals for the second card.

6. A card connector according to claim 4, further comprising a locking means for locking the open/close cover in a closed position, the locking means being arranged on a side of the second card accommodating portion opposite the rotating shaft.
